(19) United States
(12) Patent Application Publication
(10) Pub. No.: US 2025/0184356 A1
(43) Pub. Date: Jun. 5, 2025

(54) AUTOMATIC CERTIFICATE ISSUANCE FOR SERVICES USING TLS PROTOCOLS

(71) Applicant: Cisco Technology, Inc., San Jose, CA (US)

(72) Inventors: Philip Darin Lowman, Troy, MI (US); Mario Lopez, JR., Wesley Chapel, FL (US)

(21) Appl. No.: 18/528,668

(22) Filed: Dec. 4, 2023

(51) Int. Cl. H04L 9/40

(52) U.S. Cl. CPC H04L 63/166; H04L 63/0442; H04L 63/0823

(57) ABSTRACT

The present technology pertains to automatically issuing a certificate for transport layer security (TLS) communications. The technology includes receiving, by a gateway and from a service, a request for a signed certificate for use in signing a key pair to be used in encrypting communications between a client and the service. The gateway can determine a certificate authority from which to retrieve the signed certificate, and retrieve the signed certificate from the certificate authority. The gateway can send the signed certificate and the private key to the service to be installed by the service for use in securing communications with the client device using the TLS protocol.

### TECHNICAL FIELD

The present technology pertains to automatic certificate issuance, and, more specifically, to automatic certificate issuance and installation for services using transport layer security (TLS) protocols.

### BACKGROUND

A certificate is a digital object that allows networks and/or systems to verify the identity of clients and subsequently establish an encrypted network connection to a service using a Secure Sockets Layer/Transport Layer Security (SSL/TLS) protocol. Certificates are used within a cryptographic system known as a public key infrastructure that includes a public key and a private key. The public key and the private key comprise a key pair. The key pair provides a way for one party (e.g., the service) to establish the identity of another party (e.g., the client) using certificates if both parties trust a third-party, known as a certificate authority. TLS certificates act as digital identity cards to secure network communications and establish the identity of websites over the Internet as well as resources on private networks.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a system for automatic certificate issuance using a gateway in TLS protocols according to aspects of the present disclosure.

FIG. 2 illustrates an example flowchart for automatic certificate issuance using a gateway in TLS protocols according to aspects of the present disclosure.

FIG. 3 illustrates an example flowchart for certificate revocation according to aspects of the present disclosure.

FIG. 4 shows an example of a system for implementing certain aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

As used herein, the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

### Overview

In one aspect, a computer-implemented method for automatic transport layer security (TLS) certification issuance, includes receiving, by a gateway and from a client device, a first request to access a service, receiving, by the gateway and from the service, a second request for a signed certificate, determining, by the gateway, that the service utilizes a TLS protocol secured by encryption using a public key and a private key in a key pair, determining, by the gateway, a certificate authority to retrieve the signed certificate, retrieving, by the gateway, the signed certificate from the certificate authority, and sending the signed certificate to the service to be installed by the service for using in securing communications with the client device using the TLS protocol.

In another aspect, the gateway is a reverse proxy associated with the service.

In another aspect, the gateway includes a domain name service for looking up the service and determining the certificate authority to use with the service.

In another aspect, the gateway utilizes an automatic certificate management environment (ACME) protocol with the certificate authority to receive the signed certificate.

In another aspect, the service is a server associated with remote desktop connections.

In another aspect, the method may include facilitating a secured communication channel by transmitting encrypted communications between the client device and the service, where the encrypted communications are encrypted by the key pair.

In another aspect, the method may include receiving, by the gateway and from the service, an authorized request to revoke the signed certificate, and transmitting the authorized request to the certificate authority, whereby when received by the certificate authority, the certificate authority publishes revocation information associated with the authorized request and the signed certificate.

In another aspect, the key pair are associated with a second remote server.

In another aspect, the first request is received from a network device upon configuration of the gateway with the service. Other technical features may be readily apparent to one skilled in the art from the following figures, descriptions, and claims.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for automated generation, issuance, and/or installation of TLS certificates on a network. To access TLS protocols, a signed certificate is required for connections between a client and a service to ensure secure communications. If a signed certificate is not valid, a request to access a service is typically accompanied by a warning to the client indicating that the connection may not be secure. In order to secure the connection, a certificate framework on the associated network is necessary. However, facilitating and maintaining a certificate framework on a network is costly, cumbersome, and difficult, even for computer programmers and engineers skilled in the art of securing a computer network. Additionally, even if a certificate framework is in place on the network, warnings and insecure connections may still occur on client devices that are not on the network (e.g., remote desktop connections from personal computers to a work network). Due to the prevalence of these certificate warnings, users are often unintentionally trained to ignore them when they arise. This can have disastrous effects for the network, including a nefarious actor intercepting the connection to redirect requests to their own control service to exfiltrate private and confidential data.

This technology utilizes a gateway to automatically request a public certificate from a certificate authority and/or discover a certificate authority when a user wishes to access and protect any TLS protocol. For example, the technology may detect a request to access a remote desktop protocol (RDP) server, intercept the request, and verify a certificate is in place or coordinate the installation of a certificate. The gateway may initialize a connection with the RDP server prior to completing an HTTP and/or DNS challenge with a certificate authority to verify the domain. After the verification is complete, the gateway and/or RDP server may generate a key pair, comprised of a public and private key. If the gateway generates the key pair, then the gateway may also transmit the key pair to the RDP server. Following the generation of the key pair, the gateway may begin certificate management for the domain and/or the RDP server. To perform the automatic certificate installation for a server, a domain name system (DNS) is used to route a request from the server to the gateway. The gateway facilitates the retrieval (from the certificate authority), verification, and installation of a signed certificate on the server, allowing the client device to securely access the server. Typically, this process is performed through pain-staking programming and configuration, but the gateway automates the process by introducing a “middle-man” certification service that installs certificates for a service upon request from a client device.

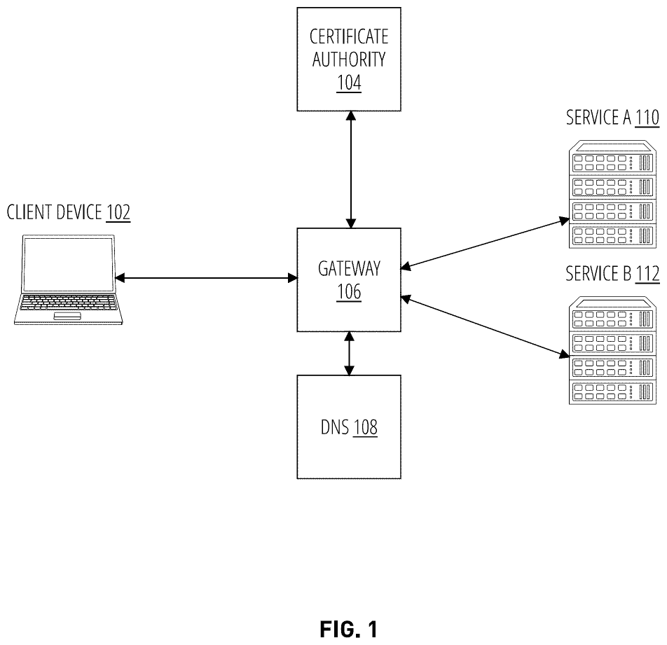

FIG. 1 illustrates an example of a system for automatic certificate issuance using a gateway for a service using TLS protocols according to aspects of the present disclosure. The system may include client device 102, which may be any device (e.g., laptop, desktop, smartphone, tablet, etc.) that can access a remote server. Client device 102 may be a device connected to the same network as the remote server, or, in some examples, client device 102 may be a remote device attempting to access the remote server (e.g., accessing a remote desktop protocol associated with a work network from a home/personal network or device).

Client device 102 may transmit a request to access the remote server via a transport layer security (TLS) protocol. In order to effectively use the TLS protocol to access the remote server, client device 102 and the remote server may exchange signed certificates to verify the authenticity of client device 102 and the remote server using a “TLS handshake” procedure. “TLS handshake” may refer to the process that initiates a communication session that uses the TLS protocol. During the TLS handshake, the two communicating sides (e.g., a client device and a server) exchange communications to acknowledge the other device, verify the other device, establish the cryptographic algorithms to be used with the TLS protocol, and agree on session keys. The TLS handshake is complete after the exchange of signed certificates between the two devices and a corresponding “finished” message from the two devices.

Once the signed certificates are exchanged, client device 102 and the remote server can exchange data securely. In order to accomplish the TLS handshake securely, large amounts of infrastructure and systems engineering on a network associated with the remote server is necessary. The systems engineering is a complicated process, often requiring many hours of tedious setup and configuration, potentially involving programming or other costs. However, a failure to complete the security component of the TLS handshake between client device 102 and the remote server could create a potentially vulnerable connection, exposing the network to malware, viruses, and attackers.

Gateway 106 functions as a “middle-man” between client device 102 and the remote server (e.g., service A 110 and/or service B 112). Gateway 106 may facilitate connections between client device 102, the remote server, and certificate authority 104 to request, issue, and install signed certificates associated with client device 102 and the remote server. By utilizing gateway 106, the systems engineering performed by a network administrator once required to accomplish the TLS connection can be replaced by the more automatic process of the present technology. Within the network, gateway 106 may function as a reverse proxy such that the remote server may request a certificate from gateway 106, and gateway 106 may use domain name service (DNS) functionality (shown in DNS 108) to identify a proper certificate authority (e.g., certificate authority 104).

In order to facilitate the automated capabilities of gateway 106 and to automatically install signed certificates, gateway 106 may be configured to be associated with the remote server (e.g., service A 110 and/or service B 112). Upon initial connection with gateway 106, the remote server may generate a new key pair (comprised of a public key and a private key). The private key may be stored on the remote server and could be shared with gateway 106 to facilitate communication with one or more components, including, but not limited to, client device 102 and certificate authority 104. The public key may be publicly available by the remote server. In some examples, gateway 106 may generate the new key pair and could share the new key pair with the remote server.

In addition to the key pair, a domain associated with the remote server may be verified. Certificate authority 104 may request one or more challenges to prove the remote server controls the domain. These challenges may be Automated Certificate Management Environment (ACME) protocol challenges, which is a protocol for automating certificate lifecycle management communications between certificate authorities and a remote server (or, in this example, the gateway). Examples of ACME challenges may include an HTTP-01 challenge, a DNS-01 challenge, and/or a TLS-ALPN-01 challenge. The ACME challenges create a mechanism for the remote server to verify control of the domain by, for example, provisioning a DNS record or provisioning an HTTP resource. In addition to the ACME challenges, certificate authority 104 may require the remote server to verify communications with the key pair (e.g., the public or private key associated with the key pair). The remote server, via gateway 106, may complete the ACME challenges and sign communications with the key pair (e.g., the public or private key associated with the key pair). Upon verification from certificate authority 104, the remote server may be identified as authorized to control the domain and the key pair may be identified as authorized to do certificate management on behalf of the domain. Using the key pair, gateway 106 may begin facilitating automatic certificate requests, issuances, and installations on behalf of the remote server.

In some examples, the key pair may be used by gateway 106 to manage certificates for more than one remote server associated with the network (e.g., issue “wildcard” certificates). For example, the key pair may be used by gateway 106 to request, issue, and install signed certificates associated with service A 110 and service B 112. In some other examples, a second key pair may be required to manage certificates for a second remote server. For example, service A 110 may be associated with a first key pair and service B 112 may be associated with a second key pair.

Once the configuration is complete, gateway 106 may begin issuing, revoking, and renewing certificates. In some examples, the request from client device 102 to access a remote server may be directed to gateway 106. DNS (e.g., a public DNS and/or a private DNS) may be configured to redirect requests directed to the remote server (e.g., service A 110 or service B 112) to gateway 106 automatically. The configuration may be performed at a network controller by a network administrator, a security protocol, controller settings, any combination thereof, or the like. For example, the request from client device 102 may include a request to access service A 110 and the request may be redirected, using DNS 108, to gateway 106.

Upon receipt of the request from client device 102, gateway 106 may forward the request to the remote server. Client device 102 may not communicate directly with the remote server to preserve optimum security on the network associated with the remote server. In some examples, the remote server may transmit an authenticated API request containing information necessary for gateway 106 to construct a Certificate Signing Request (CSR). In some other examples, the remote server may construct the CSR and request a signed certificate from gateway 106. For example, gateway 106 may forward the request sent from client device 102 to service A 110, and service A 110 may reply with a CSR to gateway 106. In some examples, the CSR may be signed with the private key associated with the key pair, which verifies the CSR came from the remote server.

Gateway 106 may transmit the CSR to certificate authority 104. In some examples, more than one certificate authority may be available to gateway 106. Gateway 106 may determine that certificate authority 104 is an appropriate authority to issue a signed certificate. Certificate authority 104 may verify the signature associated with the CSR and the overall encryption of the CSR and confirm the authenticity of the CSR. Certificate authority 104 may issue a certificate associated with the request. The certificate may be transmitted to gateway 106 and subsequently transmitted to the remote server. For example, certificate authority 104 may issue a certificate in response to the CSR and transmit the certificate to gateway 106. Gateway 106 may transmit the certificate to service A 110.

The remote server may transmit the certificate to client device 102 (via gateway 106). The certificate may include the public key associated with the remote server. Client device 102 may authenticate the certificate. Client device 102, after authenticating that the certificate is received from the remote server, transmits a message encrypted with the public key to the remote server. In some examples, the message may include a digital signature associated with client device 102. The message may comprise a session key associated with the secure connection between client device 102 and the remote server. The session key may be encrypted with the public key, such that only the private key can decrypt the session key. This security measure ensures that only the remote server can decrypt transmissions from the client device 102. In subsequent communications, the session key may be used to encrypt messages between client device 102 and the remote server in lieu of the key pair. The message is redirected, via DNS, to gateway 106. Gateway 106 may forward the message to the remote server. For example, client device 102 may transmit a message to service A 110 and DNS 108 may redirect the message to gateway 106. Gateway 106 may forward the message to service A 110. After this transmission, client device 102 may transmit a “finished” message to the remote device, indicating that client device 102 is ready to proceed with the secure connection.

The remote server may decrypt the message (e.g., the session key) using the private key of the key pair. The remote server may also receive the “finished” message from client device 102. The remote server may transmit a “finished” message to client device 102, via gateway 106, that is encrypted with the session key. The “TLS Handshake” has now been completed with gateway 106, client device 102 and the remote server. The remote server and client device 102 may communicate securely, via gateway 106 and using the session key, to encrypt and decrypt communications.

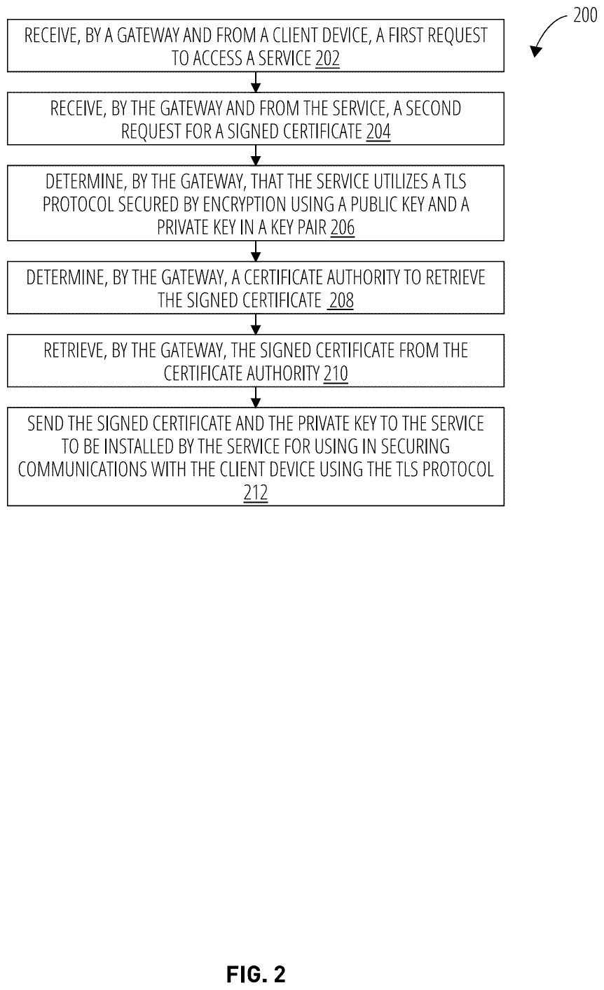

FIG. 2 illustrates an example flowchart for automatic certificate issuance using a gateway in TLS protocols according to aspects of the present disclosure. Although the example routine 200 depicts a particular sequence of operations, the sequence may be altered without departing from the scope of the present disclosure. For example, some of the operations depicted may be performed in parallel or in a different sequence that does not materially affect the function of the routine 200. In other examples, different components of an example device or system that implements the routine 200 may perform functions at substantially the same time or in a specific sequence.

According to some examples, the method includes receiving, by a gateway and from a client device, a first request to access a service at block 202. For example, the gateway 106 illustrated in FIG. 1 may receive, by a gateway and from a client device, a request to access a service. The request to access the service may initiate a configuration procedure between the gateway and the service. In some examples, the configuration procedure may be initiated upon the initial installation and/or implementation of the gateway on an enterprise network (e.g., the first request to access the service from the client device may not be required to initiate the configuration procedure). The service may be associated with a remote server associated with the enterprise network. In some examples, the gateway may also be associated with the enterprise network, such that the gateway and the remote server are connected. The gateway may facilitate and manage certificate services for the remote server.

In some examples, the gateway is also a reverse proxy associated with the service. In this manner, transmissions directed to the service and/or the remote server may be automatically redirected to the gateway. The gateway can also have DNS capabilities, and may also enable the gateway to determine an appropriate certificate authority to use with a service and/or remote server. The DNS capabilities may also allow the gateway to resolve and communicate network traffic through the gateway. In that manner, the gateway may transmit the first request to the remote server.

According to some examples, the method includes receiving, by the gateway and from the service, a second request for a signed certificate at block 204. For example, the gateway 106 illustrated in FIG. 1 may receive, by the gateway and from the service, a request for a signed certificate. In some examples, the second request may be a Certificate Signing Request generated at the remote server and/or the gateway, which indicates that the remote server associated with the service may be requesting that a new certificate be issued. The new certificate may be requested in response to the first request received from the client device, via the gateway. The second request may be directed to the gateway, which may manage and facilitate the certificate installation on behalf of the remote server.

According to some examples, the method includes determining, by the gateway, that the service utilizes a TLS protocol secured by encryption using a public key and a private key in a key pair at block 206. For example, the gateway 106 illustrated in FIG. 1 may determine, by the gateway, that the service utilizes a TLS protocol secured by encryption using a public key and a private key in a key pair. The remote service associated with the service may generate a key pair to be utilized when requesting and issuing certificates associated with the service. For example, upon initial configuration with the gateway, the remote service and/or the gateway may generate a key pair and could share the key pair with the associated component (e.g., the gateway could share the key pair with the remote service or the remote service could share the key pair with the gateway). The key pair may be used to complete a “TLS Handshake” as required to construct a secure connection between the remote server and the client device.

In some examples, the key pair is associated with a second remote server. For example, a first remote server and a second remote server may share a key pair, such that a certificate issued for a service associated with the first remote server may also be used for a service associated with the second remote server (i.e., reciprocity between certificates between servers, otherwise known as a “wildcard” certificate). For example, service A 110 illustrated in FIG. 1 and service B 112 illustrated in FIG. 1 may share a key pair.

However, in some examples, the second remote server may generate a second key pair and may share the second key pair with the gateway. For example, service A 110 illustrated in FIG. 1 may be associated with a first key pair and service B 112 illustrated in FIG. 1 may be associated with a second key pair. In this example, the gateway may manage two different key pairs for two different servers, and may differentiate between the key pairs accordingly, such that individual signed certificates may be installed for each respective server according to their individual key pairs. In some examples, the gateway may generate the second key pair on behalf of the second remote server. The gateway may share the second key pair with the second remote server and may distinguish communications associated with the first remote server and the second remote server accordingly.

According to some examples, the method includes determining, by the gateway, a certificate authority to retrieve the signed certificate at block 208. For example, the gateway 106 illustrated in FIG. 1 may determine, by the gateway, a certificate authority to retrieve the signed certificate. In some examples, one or more certificate authorities may be available to issue a signed certificate. The gateway, using data gathered from the remote service and/or the service, may select an appropriate certificate authority to receive the second request forwarded by the gateway.

The selected certificate authority may request the remote server to verify it has control over the service associated with a particular domain. The selected certificate authority may request one or more challenges (e.g., Automated Certificate Management Environment protocol challenges, such as HTTP-01 and/or DNS-01) to prove the remote server controls the domain. In some examples, the selected certificate authority may also require the remote server to verify communications with the key pair (e.g., the private key associated with the key pair). Upon verification by the selected certificate authority, the remote server may be identified as authorized to control the domain associated with the service.

According to some examples, the method includes retrieving, by the gateway, the signed certificate from the certificate authority at block 210. For example, the gateway 106 illustrated in FIG. 1 may retrieve, by the gateway, the signed certificate from the certificate authority. Upon verification of the remote server as authorized to control the domain associated with the service, the certificate authority may issue a signed certificate associated with the second request. The certificate authority may transmit the signed certificate to the gateway.

According to some examples, the method includes sending the signed certificate to the service to be installed by the service for use in securing communications with the client device using the TLS protocol at block 212. For example, the gateway 106 illustrated in FIG. 1 may send the signed certificate and the private key to the service to be installed by the service for use in securing communications with the client device using the TLS protocol. The remote server associated with the service may transmit the signed certificate and the public key of the key pair to the client device, via the gateway. The client device may authenticate the signed certificate and transmit a message encrypted with the public key. The message may include a digital signature and a session key. The session key may be encrypted by the public key, such that it can only be decrypted by the private key associated with the key pair. The remote service, via the gateway, may receive the message and reply with a message that is encrypted with the session key.

In subsequent communications, transmissions between the client device and the remote server may be encrypted with the session key. The client device and the remote server now have a secured communication channel facilitated by the gateway, which transmits encrypted communications between the client device and the service, wherein the encrypted communications are encrypted by the session key.

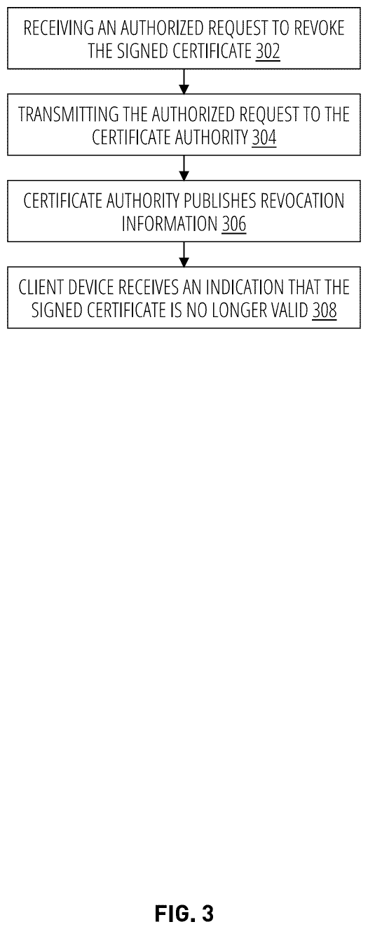

FIG. 3 illustrates an example flowchart for certificate revocation according to aspects of the present disclosure. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In a TLS protocol secured by public key cryptography, as is described above in FIG. 1 and FIG. 2, a signed certificate may be revoked before it expires, which signals that it is no longer valid. This may be necessary for one or more reasons, including, but not limited to, in the case of an affiliation change (e.g., a user associated with an allowed client device may undergo changes, such as employment status or job title), a private key compromise, a remote server decommissioning, a certificate authority compromise, or a new issue is being issued to replace the revoked certificate. Hence, revocation is a necessary part of the TLS protocol to ensure security on a network.

According to some examples, the method includes receiving an authorized request to revoke the signed certificate at block 302. For example, the gateway 106 illustrated in FIG. 1 may receive an authorized request to revoke the signed certificate. The authorized request may be from a remote server associated with a service and may be encrypted with a key pair. The remote server may transmit the authorized request to the gateway. In some examples, the authorized request may be initiated by the gateway (e.g., using an administrative user interface accessible to a network administrator).

In a similar manner, an authorized request may include a request to renew a signed certificate, instead of a request to revoke. In some examples, a signed certificate may be associated with a time limit, an expiration date, a transmission limit, a device limit, or any sort of threshold value that, when exceeded, results in the automatic revocation of a previously-installed signed certificate. The gateway may receive, from the remote server, an authorized request to renew the signed certificate if requested by a client device. Following the request to renew, the process may align with the system of FIG. 1 and/or the method described in FIG. 2.

According to some examples, the method includes transmitting the authorized request to the certificate authority at block 304. For example, the gateway 106 illustrated in FIG. 1 may transmit the authorized request to the certificate authority. Once received by the gateway, the gateway may forward the revocation or renewal request to the certificate authority that issued the original signed certificate. The certificate authority may verify the request is authorized using the key pair and/or identifying a digital signature associated with the remote server.

According to some examples, the method includes the certificate authority publishing revocation information at block 306. For example, the certificate authority 104 illustrated in FIG. 1 may publish revocation information. The certificate authority may distribute cryptographically authenticated attestations (e.g., the authorized request from the remote server) that the certificate has been revoked. In some examples, the revoked certificate may be published on a certificate revocation list or other channels accessible to client devices (e.g., Online Certificate Status Protocol (OCSP), CRLite, and/or Let's Revoke).

According to some examples, the method includes the client device receiving an indication that the signed certificate is no longer valid at block 308. For example, the client device 102 illustrated in FIG. 1 may receive an indication that the signed certificate is no longer valid. The client device may receive revocation information pertaining to the signed certificate through one or more methods, including, but not limited to, retrieving revocation status at validation time, retrieving revocation status ahead of validation and caching it, or integrating revocation checks with the TLS protocol.

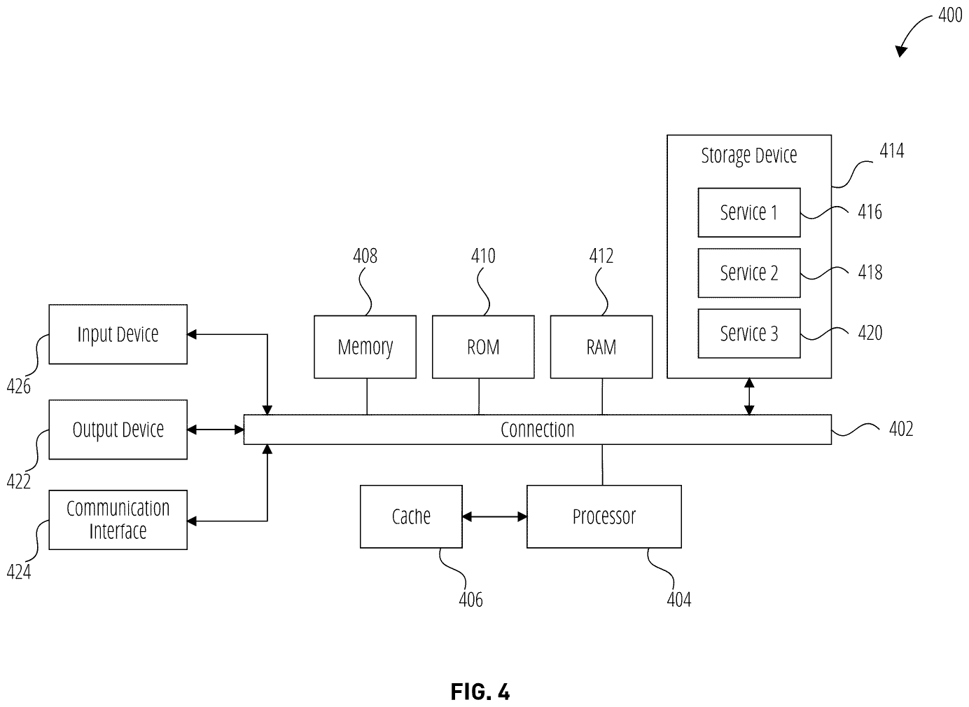

FIG. 4 shows an example of a system for implementing certain aspects of the present disclosure, which can be for example any computing device making up the system described in FIG. 1, or any component thereof in which the components of the system are in communication with each other using connection 402. Connection 402 can be a physical connection via a bus, or a direct connection into processor 404, such as in a chipset architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 400 includes at least one processing unit (CPU or processor) 404 and connection 402 that couples various system components including system memory 408, such as read-only memory (ROM) 410 and random access memory (RAM) 412 to processor 404. Computing system 400 can include a cache of high-speed memory 406 connected directly with, in close proximity to, or integrated as part of processor 404.

Processor 404 can include any general purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

As used below, any reference to a series of examples is to be understood as a reference to each of those examples disjunctively (e.g., “Examples 1-4” is to be understood as “Examples 1, 2, 3, or 4”).

Example 1 is a computer-implemented method for automatic transport layer security (TLS) certification issuance, comprising: receiving, by a gateway and from a client device, a first request to access a service; receiving, by the gateway and from the service, a second request for a signed certificate; determining, by the gateway, that the service utilizes a TLS protocol secured by encryption using a public key and a private key in a key pair; determining, by the gateway, a certificate authority to retrieve the signed certificate; retrieving, by the gateway, the signed certificate from the certificate authority; and sending the signed certificate and the private key to the service to be installed by the service for using in securing communications with the client device using the TLS protocol.

Example 2 is the computer-implemented method of example(s) 1, wherein the gateway is a reverse proxy associated with the service.

Example 3 is computer-implemented method of example(s) 1-2, wherein the gateway includes a domain name service to resolve and communicate network traffic through the gateway.

Example 4 is the computer-implemented method of example(s) 1-3, wherein the gateway utilizes an automatic certificate management environment (ACME) protocol with the certificate authority to receive the signed certificate.

Example 5 is the computer-implemented method of example(s) 1-4, wherein the service is a server associated with remote desktop connections.

Example 6 is computer-implemented method of example(s) 1-5, further comprising: facilitating a secured communication channel by transmitting encrypted communications between the client device and the service, wherein the encrypted communications are encrypted by the key pair.

Example 7 is the computer-implemented method of example(s) 1-6, further comprising: receiving, by the gateway and from the service, an authorized request to revoke the signed certificate; and transmitting the authorized request to the certificate authority, whereby when received by the certificate authority, the certificate authority publishes revocation information associated with the authorized request and the signed certificate.

Example 8 is the computer-implemented method of example(s) 1-7, wherein the key pair are associated with a second remote server.

Example 9 is the computer-implemented method of example(s) 1-8, wherein the first request is received from a network device upon configuration of the gateway with the service.

What is claimed is:

1. A computer-implemented method for automatic transport layer security (TLS) certification issuance, comprising:
receiving, by a gateway and from a client device, a first request, wherein the first request is to access a service;
receiving, by the gateway and from the service, a second request, wherein the second request is for a signed certificate;
determining, by the gateway, that the service utilizes a TLS protocol secured by encryption using a public key and a private key in a key pair;
determining, by the gateway, a certificate authority to retrieve the signed certificate;
retrieving, by the gateway, the signed certificate from the certificate authority; and
sending the signed certificate and the private key to the service to be installed by the service for using in securing communications with the client device using the TLS protocol.

2. The computer-implemented method of claim 1, wherein the gateway is a reverse proxy associated with the service.

3. The computer-implemented method of claim 1, wherein the gateway includes a domain name service to resolve and communicate network traffic through the gateway.

4. The computer-implemented method of claim 1, wherein the gateway utilizes an automatic certificate management environment (ACME) protocol with the certificate authority to receive the signed certificate.

5. The computer-implemented method of claim 1, wherein the service is a server associated with remote desktop connections.

6. The computer-implemented method of claim 5, wherein the key pair is associated with a second remote server.

7. The computer-implemented method of claim 1, further comprising:
receiving, by the gateway and from the service, an authorized request to revoke the signed certificate; and
transmitting the authorized request to the certificate authority, whereby when received by the certificate authority, the certificate authority publishes revocation information associated with the authorized request and the signed certificate.

8. The computer-implemented method of claim 1, further comprising:
facilitating a secured communication channel by transmitting encrypted communications between the client device and the service, wherein the encrypted communications are encrypted by a session key.

9. The computer-implemented method of claim 1, wherein the first request is received from a network device upon configuration of the gateway with the service.

10. A system comprising:
one or more processors; and
a memory storing instructions that, when executed by the one or more processors, configure the system to:
receive, by a gateway and from a client device, a first request, wherein the first request is to access a service;
receive, by the gateway and from the service, a second request, wherein the second request is for a signed certificate;
determine, by the gateway, that the service utilizes a TLS protocol secured by encryption using a public key and a private key in a key pair;
determine, by the gateway, a certificate authority to retrieve the signed certificate;
retrieve, by the gateway, the signed certificate from the certificate authority; and
send the signed certificate and the private key to the service to be installed by the service for using in securing communications with the client device using the TLS protocol.

11. The system of claim 10, wherein the gateway is a reverse proxy associated with the service.

12. The system of claim 10, wherein the gateway includes a domain name service to resolve and communicate network traffic through the gateway.

13. The system of claim 10, wherein the gateway utilizes an automatic certificate management environment (ACME) protocol with the certificate authority to receive the signed certificate.

14. The system of claim 10, wherein the service is a server associated with remote desktop connections.

15. The system of claim 14, wherein the key pair is associated with a second remote server.

16. The system of claim 10, wherein the instructions further configure the system to:
receive, by the gateway and from the service, an authorized request to revoke the signed certificate; and
transmit the authorized request to the certificate authority, whereby when received by the certificate authority, the certificate authority publishes revocation information associated with the authorized request and the signed certificate.

17. The system of claim 10, wherein the instructions further configure the system to:
facilitate a secured communication channel by transmitting encrypted communications between the client device and the service, wherein the encrypted communications are encrypted by a session key.

18. A non-transitory computer-readable storage medium, the non-transitory computer-readable storage medium including instructions that when executed by a computer, cause the computer to:
receive, by a gateway and from a client device, a first request, wherein the first request is to access a service;
receive, by the gateway and from the service, a second request, wherein the second request is for a signed certificate;
determine, by the gateway, that the service utilizes a TLS protocol secured by encryption using a public key and a private key in a key pair;
determine, by the gateway, a certificate authority to retrieve the signed certificate;
retrieve, by the gateway, the signed certificate from the certificate authority; and
send the signed certificate and the private key to the service to be installed by the service for using in securing communications with the client device using the TLS protocol.

19. The non-transitory computer-readable storage medium of claim 18, wherein the gateway includes a domain name service to resolve and communicate network traffic through the gateway.

20. The non-transitory computer-readable storage medium of claim 18, wherein the instructions further configure the computer to:
receive, by the gateway and from the service, an authorized request to revoke the signed certificate; and
transmit the authorized request to the certificate authority, whereby when received by the certificate authority, the certificate authority publishes revocation information associated with the authorized request and the signed certificate.
